(19) United States
(12) Patent Application Publication
(10) Pub. No.: US 2019/0021828 A1
(43) Pub. Date: Jan. 24, 2019

(54) ORAL DEVICE

(71) Applicant: HEALTH CORPORATION OF GALILEE MEDICAL CENTER, NAHARIYA (IL)

(72) Inventor: ARKADIY BELENKIY, MAALOT (IL)

(21) Appl. No.: 16/069,364

(22) PCT Filed: Jan. 11, 2017
(86) PCT No.: PCT/IL2017/050034

§ 371 Date: Jul. 11, 2018

Related U.S. Application Data
(60) Provisional application No. 62/276,989, filed on Jan. 11, 2016.

(51) Int. Cl. A61C 17/02; A46B 9/04; A46B 11/00; A46B 15/00; A46B 11/06; B65D 35/02

(52) U.S. Cl. CPC A61C 17/0208; A46B 9/04; A46B 11/0041; A46B 2200/1066; A46B 11/06; B65D 35/02; A61C 17/0202; A46B 15/0053

(57) ABSTRACT

An oral care device comprising: a hollow shaft having a suction and a cleaning portion wherein the suction and the cleaning portion are fluidically connected; a suction activator provided to the shaft; a material supply channel comprising at least one material supply opening, wherein the material supply opening is configured to reversibly receive a pod; and at least one opening at the cleaning portion fluidically connected to a suction. In addition, there is provided a pod configured to be attached to an oral care device as disclosed above, the pod comprising a body configured to contain a material for treating an oral cavity, a neck, and a seal separating the body from the neck. A kit comprising the oral care device and a plurality of pods, a method for using the same, and additional embodiments of the present subject matter, are disclosed herein.

### CROSS-REFERENCE TO RELATED APPLICATIONS

The present application claims priority to U.S. provisional patent application No. 62/276,989, filed 11 Jan. 2016.

### FIELD

The invention subject matter relates to oral care devices. More particularly, the present subject matter relates to oral care devices for ventilated patients.

### BACKGROUND

U.S. Pat. No. 6,238,213 describes a disposable suction oral care device. The device has an elongated, hollow shaft having a suction end and a cleansing end. A head is located at the cleansing end, the head having opposite scrub elements such as bristles and a foam pad. A suction port communicates with each scrub element. Each suction port leads to the suction end. A suction control is located at the suction end. The suction control includes a suction regulation opening which is shaped to be manipulated by a thumb or a finger. A center channel is provided through the bristles, separating the bristles into two clusters. The suction port communicating with the bristles is located in the center channel. The foam pad includes an orifice aligned with the suction port which communicates with the foam pad to provide a separate source of suction at the foam pad, as well.

Such devices are routinely used at intensive care units in hospitals. During employment of such devices on ventilated patients, a disinfectant is used, followed by lubrication of the oral cavity with a suitable lubricant, such as edible oil, and/or application of a mouth moisturizer to the oral cavity. Typically, the disinfectant, lubricant and mouth moisturizer materials are spread or poured onto the scrub elements before the device is introduced into the patient's oral cavity. Practically, oral care treatment of a ventilated patient include application of a disinfectant, typically more than once, to the device, insertion of the device into the patient's oral cavity, withdrawal of the device, application of a lubricant and/or moisturizer to the device, and again insertion of the device into the patient's oral cavity. However, inevitably some of the material spills, wetting the bed and/or patient and the caregiver. The caregiver, wearing gloves, has difficulty manipulating the device and opening the containers of the materials, in particular after one introduction of the device into the oral cavity (thereby covering the gloves with mucus as well), and typically the device needs to be recovered with the materials a number of times to effectively apply sufficient material. In fact, application of the lubricant and/or moisturizer even once to the oral cavity is cumbersome.

Furthermore, often during treatment of a ventilated patient with the device the patient may experience paroxysm that may lock the patient's jaws while the device is inside the patient's oral cavity. This phenomenon may eliminate repeated insertion and removal of the device from an oral cavity of a ventilated patient.

Therefore, there is a need for an oral care device, particularly for the treatment of ventilated patient's that overcomes the aforementioned drawbacks of the currently used oral care devices.

### SUMMARY

Unless otherwise defined, all technical and scientific terms used herein have the same meaning as commonly understood by one of ordinary skill in the art to which this subject matter belongs. Although methods and materials similar or equivalent to those described herein can be used in the practice or testing of the present subject matter, suitable methods and materials are described below. In case of conflict, the patent specification, including definitions, will control. In addition, the materials, methods, and examples are illustrative only and not intended to be limiting.

According to one aspect of the present subject matter, there is provided an oral care device comprising: a hollow shaft having a suction and a cleaning portion wherein the suction and the cleaning portion are fluidically connected; a suction activator provided to the shaft; a material supply channel comprising at least one material supply opening, wherein the material supply opening is configured to reversibly receive a pod; and at least one opening at the cleaning portion fluidically connected to a suction.

According to one embodiment, the hollow shaft is straight.

According to another embodiment, the hollow shaft is bent.

According to yet another embodiment, the hollow shaft is bendable.

According to a further embodiment, the cleaning portion is rounded.

According to yet a further embodiment, the cleaning portion further comprises a plurality of bristles.

According to still a further embodiment, the plurality of bristles extend all through the cleaning portion.

According to an additional embodiment, the plurality of bristles are configured not to injure soft tissue in an oral cavity of a patient.

According to another embodiment, each of the at least one material supply opening comprises at least one hollow needle, extending from the material supply channel, and directed outwardly towards the at least one opening.

According to yet another embodiment, each of the at least one hollow needle comprises an opening, configured to receive material from a pod connected to the material supply opening.

According to another aspect of the present subject matter, there is provided a pod configured to be attached to an oral care device as disclosed above, the pod comprising a body configured to contain a material for treating an oral cavity, a neck, and a seal separating the body from the neck.

According to one embodiment, the seal is configured to be perforated by the at least one hollow needle.

According to another embodiment, the body is pressable.

According to yet another aspect of the present subject matter, there is provided a kit comprising an oral care device as disclosed above, and at least one pod as disclosed above.

According to still another aspect of the present subject matter, there is provided a method for treating an oral cavity, the method comprising: inserting an oral care device into a patient's oral cavity; engaging a first pod containing a first composition with the device such as to introduce the first composition into the device; squeezing the first pod to disperse the first composition in the oral cavity; scrubbing the oral cavity with the device and the first composition; disengaging the first pod from the device while retaining the device in the oral cavity; engaging a second pod containing a second composition with the device, such as to introduce the second composition into the device; squeezing the second pod to disperse the second composition in the oral cavity; scrubbing the oral cavity with the device and the second composition; and withdrawing the device and the second pod from the oral cavity.

According to one embodiment, a plurality of pods may be engaged with the device and disengaged after usage, one after the other.

According to another embodiment a plurality of pods may be engaged with the device and disengaged after usage, in parallel.

### BRIEF DESCRIPTION OF THE DRAWINGS

Embodiments are herein described, by way of example only, with reference to the accompanying drawings. With specific reference now to the drawings in detail, it is stressed that the particulars shown are by way of example and for purposes of illustrative discussion of the preferred embodiments, and are presented in the cause of providing what is believed to be the most useful and readily understood description of the principles and conceptual aspects of the embodiments. In this regard, no attempt is made to show structural details in more detail than is necessary for a fundamental understanding, the description taken with the drawings making apparent to those skilled in the art how several forms may be embodied in practice.

In the drawings:

FIG. 1a schematically illustrates, according to an exemplary embodiment, a cross sectional view of a kit comprising an oral care device and a pod engaged with the device.

FIG. 1b schematically illustrates, according to an exemplary embodiment, an upper view of a kit comprising an oral care device and a pod engaged with the device.

FIG. 2a schematically illustrates, according to an exemplary embodiment, a side view of a pod.

FIG. 2b schematically illustrates, according to an exemplary embodiment, a bottom view of a pod.

### DESCRIPTION OF THE PREFERRED EMBODIMENTS

Before explaining at least one embodiment in detail, it is to be understood that the subject matter is not limited in its application to the details of construction and the arrangement of the components set forth in the following description or illustrated in the drawings. The subject matter is capable of other embodiments or of being practiced or carried out in various ways. Also, it is to be understood that the phraseology and terminology employed herein is for the purpose of description and should not be regarded as limiting. In discussion of the various figures described herein below, like numbers refer to like parts. The drawings are generally not to scale.

For clarity, non-essential elements were omitted from some of the drawings.

According to one aspect of the present subject matter, there is provided an oral care device comprising: a hollow shaft having a suction and a cleaning portion wherein the suction and the cleaning portion are fluidically connected; a suction activator provided to the shaft; a material supply channel comprising at least one material supply opening, wherein the material supply opening is configured to reversibly receive a pod; and at least one opening at the cleaning portion fluidically connected to a suction.

According to another aspect of the present subject matter, there is provided a pod configured to be attached to an oral care device as disclosed above, the pod comprising a body configured to contain a material for treating an oral cavity, a neck, and a seal separating the body from the neck.

According to yet another aspect of the present subject matter, there is provided a kit comprising an oral care device as disclosed above, and at least one pod as disclosed above.

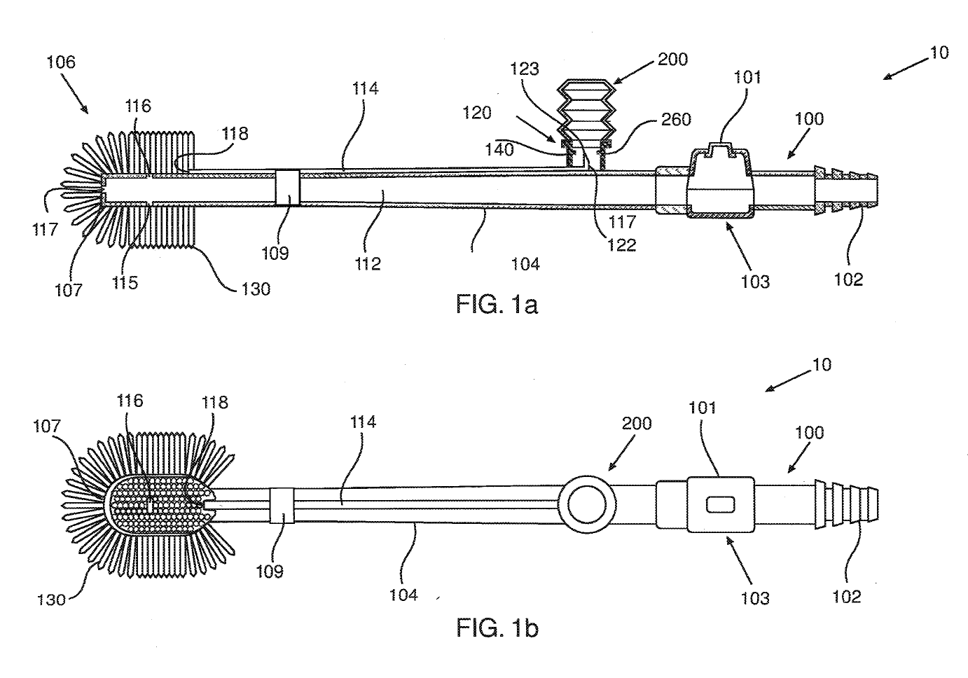

FIG. 1a schematically illustrates, according to an exemplary embodiment, a cross sectional view of a kit 10 comprising an oral care device 100 and at least one pod 200 reversibly engaged with the device 100. The oral care device 100 comprises a suction 102 configured to be connected to a main suction plug, a hollow shaft 104 and a cleaning portion 106, wherein the hollow shaft 104 connects the suction 102 to the cleaning portion 106, and a suction activator 103 positioned over the hollow shaft 104 and configured to activate suction along the hollow shaft 104. The suction activator 103 is provided with a suction opening 101 through which suction activation may be controlled. When the device 10 is connected to a main suction plug through the suction 102, and the suction opening 101 is open, no suction is activated along the hollow shaft 104 since air is sucked through the suction opening 101. When the suction opening 101 is blocked, for example by a user's finger, suction is activated along the hollow shaft 104. The hollow shaft 104 comprises a suction channel 112 passing through the hollow shaft 104. The device 100 further comprises a material supply channel 114 comprising at least one material supply opening 120 at the hollow shaft 104. On each material supply opening 120 a pod 200 can be mounted and very easily connected. The material supply channel 114 further comprises at least one opening 118 at the cleaning portion 106. The at least one opening 120 of the material supply channel 114, each of which is configured to reversibly receive a pod 200, is provided with at least one hollow needle 122, extending from the material supply channel 114 and directed outwardly towards the at least one opening 120. An opening 123 is provided at the end of each hollow needle 122, the opening 123 is configured to receive material from a pod 200 connected to the material supply opening 120. The material supply channel 114 extends to at least one side of the cleaning portion 106 and has at least one opening 118. The cleaning portion 106 is further provided at least one opening, for example openings 115, 116, and 117 that are fluidically connected to the suction channel 112 through which fluids, mucus and matter from the oral cavity may be sucked and transferred to a suction channel, for example a main suction channel (not shown), through suction 102 that is fluidically connected with the suction channel 112.

According to one embodiment, the suction 102 is configured to be connected straight directly to a main suction channel, for example a tube of the main suction channel. According to another embodiment, the suction 102 is configured to be connected to a main suction channel while being rotated. This may be achieved, for example, by attaching a ring (not shown) over the suction 102, so that a tube of a main suction channel fits onto the ring, and the ring enables the device 100 to rotate relative to the tube of the main suction channel.

FIG. 1b schematically illustrates, according to an exemplary embodiment, an upper view of a kit comprising an oral care device 100 and a pod 200 engaged with the device 100. The cleaning portion 106 has preferably a rounded shape, namely a spherical or elliptic shape. In other words, the cleaning portion 106 has no directionality. According to some embodiments, other configurations may be used. According to another embodiment, the cleaning portion 106 is provided with a plurality of bristles 130 preferably extending all through the cleaning portion 106. According to yet another embodiment, the bristles 130 extend in all directions, i.e. in 360°, from the surface of the cleaning portion. According to a further embodiment, the bristles 130 are configured not to injure soft tissue in the oral cavity of a patient during treatment of the oral cavity with the device 100. According to yet a further embodiment, the bristles 130 are made of a soft material, so that they will not injure soft tissue in the oral cavity. According to one embodiment, openings of suction, for example openings 115, 116, 117 are provided between the bristles 130 of the cleaning portion. In this upper view, one can see the material channel 114 that is adjacent to the hollow shaft 104 and extends between the pod 200 and the opening 18. It should be noted that the material channel 114 can be incorporated within the side wall of the hollow shaft 104.

According to one embodiment, the cleaning portion 106 comprises a tip 107. According to another embodiment, the tip 107 of the cleaning portion 106 is straight. According to yet another embodiment, the tip 107 of the cleaning portion 106 is rounded. According to a preferred embodiment, the tip 107 of the cleaning portion 106 is configured not to injure soft tissue of an oral cavity of a patient treated with the device 100.

According to one embodiment, the hollow shaft 104 is straight. According to another embodiment the hollow shaft 104 is bendable, namely the hollow shaft 104 is bent at a bending point 109, as illustrated in FIGS. 1a-1b. According to yet another embodiment, the hollow shaft 104 may be bent at any point along its length, namely, the bending point 109 may be positioned anywhere along the hollow shaft 104. According to a preferred embodiment, the bending point 109 is positioned adjacent to the cleaning portion 106. According to a further embodiment, the hollow shaft 104 is bent at the bending point 109 forming an angle between the hollow shaft 104 and the cleaning portion 106. According to another preferred embodiment, the angle between the hollow shaft 104 and the cleaning portion 106, formed at the bending point 109, allows convenient insertion of the device 100 into an oral cavity of a patient, and treatment of the oral cavity. Thus, any angle may be formed between the hollow shaft 104 and the cleaning portion 106. According to an additional embodiment, the angle between the hollow shaft 104 and the cleaning portion 106, formed at the bending point 109, is in the range of substantially 0-90°. According to a further embodiment, the hollow shaft 104 is permanently bent at the bending point 109 at a certain angle. According to yet a further embodiment, the hollow shaft 104 is transiently bent at the bending point 109, namely the bending point 109 is configured to be bent by a user at any angle as desired by a user. Accordingly, the bending point 109 is made of a material that allows free bending at the bending point 109 by the user. Since the bending point 109 may be positioned anywhere along the hollow shaft 104, the entire shaft hollow 104 may be made of a material that allows free bending at the bending point 109 by the user.

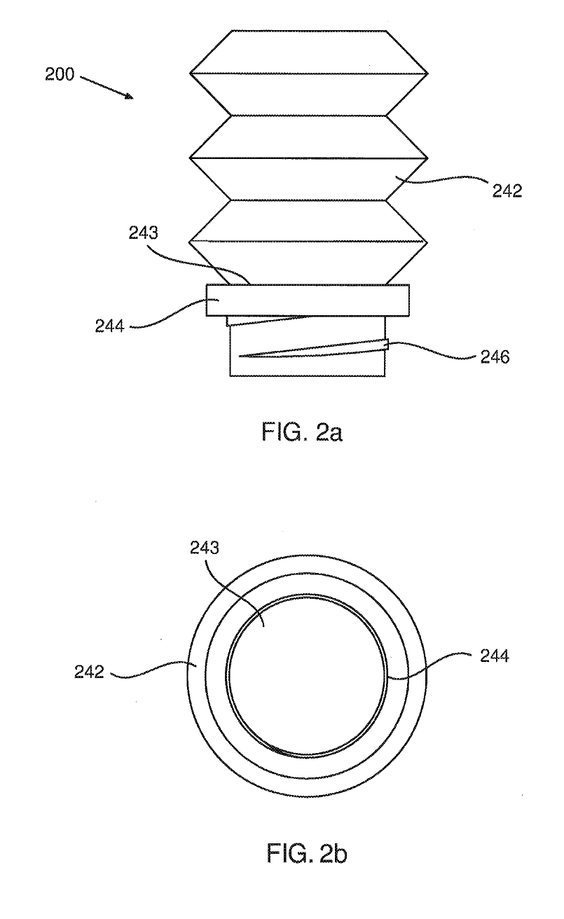

FIG. 2a schematically illustrates, according to an exemplary embodiment, a side view of a pod. FIG. 2b schematically illustrates, according to an exemplary embodiment, a bottom view of a pod 200. It should be noted that since the device 10 comprises at least one opening 120 and its components, as described above, at least one pod 200 may be attached to the device 10. Each pod 200 may contain a different material for treating an oral cavity. According to one embodiment, the pod 200 comprises a body 242, configured to contain a material for treating an oral cavity, a neck 244, and a seal 243 separating the body 242 from the neck 243. A material such as disinfectant is received within the body 242 and sealed with the seal 243 (as illustrated in FIG. 2b). Turning back to FIG. 1, the cleaning device 100 comprises an externally extended threaded port 140 having a short internal thread 260. The neck 244 has a short external thread 246, as shown in FIG. 2a, that can be screwed into the port 140. The pod 200 is engaged with the port 140 by placing the neck 244 in the port 140 and screwing the pod 200 for about half a turn on the port 140. As the pod 200 descends into the port 140, the at least one hollow needle 122 that protrudes beneath the supply opening 120 perforates the seal 243 and the composition can enter the material supply channel 114 from the body 242 of the pod 200. Thus, according to this embodiment, the seal 243 is configured to be perforated by the at least one hollow needle. This may be achieved, for example, by making the seal 243 from a material that in one hand is strong enough to keep the body 242 sealed, thus avoiding exit of a material contained in the body, and on the other hand the material of which the seal 243 is made allows penetration of the at least one hollow needle 122 into the body 242 of the pod 200.

According to other embodiments, the aforementioned features may be different but the same principles apply, for example the pod 200 may have a neck 244 that is wider than the port 140. Engagement can be with matching threads, a quick-connect (slot and knob), and the like, without limiting the scope of the present subject matter.

The body 242 of the pod 200 has a structure of a bellows such that pressing the body 242 downwardly towards the port 140 enables and increases the flow of the composition through the material supply channel 114 to be dispensed through the openings in the cleaning portion 106. Releasing the body 242 or lessening the pressure decreases the flow. Thus, according to this embodiment, the body 242 of the pod 200 is pressable.

According to some preferred embodiments (not shown), the opening 118 on the cleaning portion 106 through which compositions, such as a disinfectant, are delivered, is distant from suction ports in the cleaning portion 106, so that the compositions are not immediately sucked in upon release from the cleaning portion 106.

According to still another aspect, the present subject matter provides a method for treating an oral cavity, the method comprising: inserting an oral care device 100 into a patient's oral cavity; engaging a first pod 200 containing a first composition with the device 100 such as to introduce the first composition into the device 100; squeezing the first pod 200 to disperse the first composition in the oral cavity; scrubbing the oral cavity with the device 100 and the first composition; disengaging the first pod 200 from the device while retaining the device 100 in the oral cavity; engaging a second pod 200 containing a second composition with the device 100, such as to introduce the second composition into the device 100; squeezing the second pod 200 to disperse the second composition in the oral cavity; scrubbing the oral cavity with the device 100 and the second composition; withdrawing the device 100 and the second pod 200 from the oral cavity.

According to another embodiment, a plurality of pods 200 may be engaged with the device 100 and disengaged after usage, one after the other. According to yet another embodiment, a plurality of pods 200 may be engaged with the device 100 and disengaged after usage, in parallel. An advantage of the kit 10 of the present subject matter is that allows changing

According to some embodiments, the kit 10 allows performing the entire procedure of scrubbing and disinfecting/lubricating/hydrating with a single insertion of the device 100 into the patient's oral cavity, with minimum spill of materials onto the patient, or bed or user, as well as with minimal risk of contamination. The device 100 and pods 200 are preferably disposable to minimize contamination; however according to some embodiments, a pod 200 may be used multiple times, in particular with patients that are not ventilated and independently breathe, such as patients suffering from dementia. In such cases, the composition that is delivered may be a tooth-paste or mouthwash instead of the disinfectant/lubricant.

It is appreciated that certain features of the subject matter, which are, for clarity, described in the context of separate embodiments, may also be provided in combination in a single embodiment. Conversely, various features of the subject matter, which are, for brevity, described in the context of a single embodiment, may also be provided separately or in any suitable sub combination.

Although the subject matter has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. An oral care device comprising:
a hollow shaft having a suction and a cleaning portion wherein the suction and the cleaning portion are fluidically connected;
a suction activator provided to the shaft;
a material supply channel comprising at least one material supply opening, wherein the material supply opening is configured to reversibly receive a pod; and
at least one opening at the cleaning portion fluidically connected to a suction.

2. The oral care device of claim 1, wherein the hollow shaft is straight.

3. The oral care device of claim 1, wherein the hollow shaft is bent.

4. The oral care device of claim 1, wherein the hollow shaft is bendable.

5. The oral care device of claim 1, wherein the cleaning portion is rounded.

6. The oral care device of claim 1, wherein the cleaning portion further comprises a plurality of bristles.

7. The oral care device of claim 6, wherein the plurality of bristles extends all through the cleaning portion.

8. The oral care device of claim 6, wherein the plurality of bristles is configured not to injure soft tissue in an oral cavity of a patient.

9. The oral care device of claim 1, wherein each of the at least one material supply opening comprises at least one hollow needle, extending from the material supply channel, and directed outwardly towards the at least one opening.

10. The oral care device of claim 9, wherein each of the at least one hollow needle comprises an opening, configured to receive material from a pod connected to the material supply opening.

11. A pod configured to be attached to an oral care device according to claim 1, the pod comprising a body configured to contain a material for treating an oral cavity, a neck, and a seal separating the body from the neck.

12. The pod of claim 11, wherein the seal is configured to be perforated by the at least one hollow needle.

13. The pod of claim 11, wherein the body is pressable.

14. A kit comprising an oral care device according to claim 1, and at least one pod configured to be attached to the oral care device, the pod comprising a body configured to contain a material for treating an oral cavity, a neck, and a seal separating the body from the neck.

15. A method for treating an oral cavity, the method comprising:
inserting an oral care device into a patient's oral cavity;
engaging a first pod containing a first composition with the device such as to introduce the first composition into the device;
squeezing the first pod to disperse the first composition in the oral cavity;
scrubbing the oral cavity with the device and the first composition;
disengaging the first pod from the device while retaining the device in the oral cavity;
engaging a second pod containing a second composition with the device, such as to introduce the second composition into the device;
squeezing the second pod to disperse the second composition in the oral cavity;
scrubbing the oral cavity with the device and the second composition; and
withdrawing the device and the second pod from the oral cavity.

16. The method of claim 15, wherein a plurality of pods may be engaged with the device and disengaged after usage, one after the other.

17. The method of claim 15, wherein a plurality of pods may be engaged with the device and disengaged after usage, in parallel.
